(19) United States
(12) Patent Application Publication
(10) Pub. No.: US 2022/0163348 A1
(43) Pub. Date: May 26, 2022

(54) POSITIONING METHOD AND ELECTRONIC DEVICE

(71) Applicant: GOERTEK INC., Shandong (CN)

(72) Inventors: Fangfang ZHANG, Shandong (CN); Weiliang CHEN, Shandong (CN)

(73) Assignee: GOERTEK INC., Shandong (CN)

(21) Appl. No.: 17/310,631

(22) PCT Filed: Dec. 28, 2019
(86) PCT No.: PCT/CN2019/129573

§ 371 Date: Aug. 13, 2021

(30) Foreign Application Priority Data
Feb. 13, 2019 (CN) 201910116369.1

(51) Int. Cl. G01C 21/00; G01C 21/16

(52) U.S. Cl. CPC G01C 21/3844; G01C 21/16

(57) ABSTRACT

A positioning method and an electronic device are provided. The method comprises: acquiring azimuth angle data collected by a first sensor and acceleration data collected by a second sensor respectively (101); judging whether a turning event occurs at a current moment based on the azimuth angle data and the acceleration data (102); and if a turning event occurs, generating a positioning request to acquire position data of the current moment based on the positioning request for positioning and displaying (103). In the method, the positional change caused by a turning action is identified and positioned, so that a motion trajectory displayed in a map reflects the actual movement more truly.

### CROSS-REFERENCE TO RELATED APPLICATION

This application is a U.S. National-Stage entry under 35 U.S.C. § 371 based on International Application No. PCT/CN2019/129573, filed Dec. 28, 2019 which was published under PCT Article 21(2) and which claims priority to Chinese Application No. 201910116369.1, filed Feb. 13, 2019, which are all hereby incorporated herein in their entirety by reference.

### TECHNICAL FIELD

This Application pertains to the field of electronic information technology, and more particularly, to a positioning method and an electronic device.

### BACKGROUND

At present, more and more wearable devices are provided with the function of positioning. The wearable device mainly uses the built-in positioning instrument to obtain at intervals of time the longitude and latitude values of the user at the current moment by using the GPS, WIFI or base station. The longitude and latitude values acquired are used as positioning points, and the positioning points obtained at adjacent moments are linearly connected to obtain the motion trajectory of the user and display it on the map.

However, the above positioning method cannot take into account the surrounding environment. For example, the motion trajectory of the user displayed on the map may traverse a building or different blocks, so that the motion trajectory of the user cannot reflect the real movement of the user. However, if the user's geographic position is uploaded to a third-party application that can identify road environment to correct the positioning points, the user information will be leaked, and the security of the user information cannot be guaranteed. In addition, other objects, desirable features and characteristics will become apparent from the subsequent summary and detailed description, and the appended claims, taken in conjunction with the accompanying drawings and this background.

### SUMMARY

The embodiments of the present disclosure provide a positioning method, an electronic device and a positioning server. By identifying and positioning the positional change caused by a turning action, the motion trajectory displayed on the map reflects the actual movement more truly.

The present disclosure provides a positioning method, comprising:

acquiring azimuth angle data collected by a first sensor and acceleration data collected by a second sensor respectively;

judging whether a turning event occurs at a current moment based on the azimuth angle data and the acceleration data; and

if a turning event occurs, generating a positioning request to acquire position data of the current moment based on the positioning request for positioning and displaying.

Preferably, judging whether a turning event occurs at a current moment based on the azimuth angle data and the acceleration data comprises:

determining whether a to-be-identified turning event occurs at the current moment based on the azimuth angle data; and

if a to-be-identified turning event occurs, determining whether the to-be-identified turning event is the turning event based on the acceleration data.

Preferably, determining whether a to-be-identified turning event occurs at the current moment based on the azimuth angle data comprises:

calculating an angle difference between a first azimuth angle data collected at a start moment in a preset time range and a second azimuth angle data collected at an end moment in the preset time range;

determining whether the angle difference is greater than an angle threshold; and

if the angle difference is greater than the angle threshold, determining that the to-be-identified turning event occurs at the current moment.

Preferably, if a to-be-identified turning event occurs, determining whether the to-be-identified turning event is the turning event based on the acceleration data comprises:

determining a motion state and a motion characteristic value corresponding to the to-be-identified turning event based on the acceleration data;

judging whether the motion state is of a motion type or a non-motion type;

if the motion state is of a motion type, determining that the to-be-identified turning event is the turning event when the motion characteristic value satisfies a preset motion turning condition; and

if the motion state is of a non-motion type, determining that the to-be-identified turning event is the turning event when the motion characteristic value satisfies a preset non-motion turning condition.

Preferably, the motion characteristic value includes one or more of a standard deviation, a kurtosis, a characteristic ratio of the standard deviation to the kurtosis, a kurtosis difference, a fluctuation difference and a standard deviation difference of the acceleration data collected within a current preset time period;

wherein the kurtosis difference is a difference between a kurtosis of the acceleration data collected within the current preset time period and a kurtosis mean value of at least one previous preset time period adjacent to the current preset time period;

the fluctuation difference is a difference between a fluctuation value of the acceleration data collected within the current preset time period and the fluctuation mean value of at least one previous preset time period adjacent to the current preset time period; and

the standard deviation difference is an absolute difference between a standard deviation of the acceleration data collected within the current preset time period and a standard deviation mean value of at least one previous preset time period adjacent to the current preset time period.

Preferably, if the motion state is of a motion type, determining that the to-be-identified turning event is the turning event when the motion characteristic value satisfies a preset motion turning condition comprises:

if the motion state is of a motion type, judging whether the standard deviation is less than a first standard deviation threshold and whether the characteristic ratio is less than a first characteristic ratio threshold;

if the standard deviation is less than the first standard deviation threshold and the characteristic ratio is less than the first characteristic ratio threshold, and at the same time, the kurtosis difference is less than or equal to a first kurtosis difference threshold, and/or the kurtosis is less than or equal to a first kurtosis threshold, and/or the fluctuation difference is less than or equal to a first fluctuation difference threshold, determining that the motion characteristic value satisfies the preset motion turning condition, and determining that the to-be-identified turning event is the turning event;

if the standard deviation is greater than or equal to the first standard deviation threshold, and/or the characteristic ratio is greater than or equal to the first characteristic ratio threshold, further judging whether the fluctuation difference is greater than the first fluctuation threshold;

if the fluctuation difference is greater than the first fluctuation threshold, and at the same time, the standard deviation difference is less than or equal to a first standard deviation difference threshold, and/or the kurtosis difference is less than the first kurtosis difference threshold, and the kurtosis is less than or equal to the first kurtosis threshold, determining that the motion characteristic value satisfies the preset motion turning condition;

if the fluctuation difference is less than or equal to the first fluctuation threshold, determining that the motion characteristic value satisfies the preset motion turning condition, and determining that the to-be-identified turning event is the turning event.

Preferably, if the motion state is of a non-motion type, determining that the to-be-identified turning event is the turning event when the motion characteristic value satisfies a preset non-motion turning condition comprises:

if the motion state is of a non-motion type, determining whether the fluctuation difference is greater than a second fluctuation difference threshold;

if the fluctuation difference is greater than the second fluctuation difference threshold, further judging whether the characteristic ratio is less than a second characteristic ratio threshold;

if the characteristic ratio is less than the second characteristic ratio threshold, and at the same time, the kurtosis difference is less than or equal to a second kurtosis difference threshold, and/or the kurtosis is less than or equal to a second kurtosis threshold, and/or the standard deviation difference is less than or equal to a second standard deviation difference threshold, determining that the motion characteristic value satisfies the preset non-motion turning condition, and determining that the to-be-identified turning event is the turning event; if the characteristic ratio is greater than or equal to the second characteristic ratio threshold, determining that the motion characteristic value satisfies the preset non-motion turning condition;

if the fluctuation difference is less than or equal to the second fluctuation difference threshold, further judging whether the characteristic ratio is less than a third characteristic ratio threshold;

if the characteristic ratio is less than the third characteristic ratio threshold, and at the same time, the kurtosis difference is less than or equal to a third kurtosis difference threshold, and/or the kurtosis is less than or equal to a third kurtosis threshold, and/or the standard deviation difference is less than or equal to a third standard deviation difference threshold, determining that the motion characteristic value satisfies the preset non-motion turning condition;

if the characteristic ratio is greater than or equal to the third characteristic ratio threshold, determining that the motion characteristic value satisfies the preset non-motion turning condition, and determining that the to-be-identified turning event is the turning event.

Preferably, if a turning event occurs, generating a positioning request to acquire position data of the current moment based on the positioning request for positioning and displaying comprises:

if a turning event occurs, generating a positioning request;

sending the positioning request to a server end to enable the server end to acquire position data of a current moment based on the positioning request;

generating a motion trajectory based on positioning points determined by the position data; and

outputting the motion trajectory generated by the server end in a map.

The present disclosure provides an electronic device comprising a processing module and a storage module; the storage module is for storing one or more computer instructions, wherein the one or more computer instructions are invoked and executed by the processing module;

the processing module is for:

acquiring azimuth angle data collected by a first sensor and acceleration data collected by a second sensor respectively;

judging whether a turning event occurs at a current moment based on the azimuth angle data and the acceleration data; and

if a turning event occurs, generating a positioning request to acquire position data of the current moment based on the positioning request for positioning and displaying.

The present disclosure further provides a computer readable storage medium storing a computer program, and the computer program, when executed by a computer, can implement any one of the above positioning methods.

The embodiments of the present disclosure provide a positioning method and an electronic device. In the method, the azimuth angle data collected by the first sensor and the acceleration data collected by the second sensor are acquired respectively. It is judged whether a turning event occurs at a current moment based on the azimuth angle data and the acceleration data, so as to identify whether a positional change caused by a turning action occurs. If a turning event occurs, a positioning request is generated to acquire position data of the current moment based on the positioning request for positioning and displaying. Thus, the turning position is positioned so that the motion trajectory displayed on the map reflects the actual movement more truly.

### BRIEF DESCRIPTION OF DRAWINGS

The present invention will hereinafter be described in conjunction with the following drawing figures, wherein like numerals denote like elements, and:

FIG. 1 shows a flowchart of an embodiment of a positioning method according to the present disclosure;

FIG. 2 shows a flowchart of an embodiment of a positioning method according to the present disclosure;

FIG. 3(a) to FIG. 3(b) show a schematic diagram of determining whether a to-be-identified turning event has occurred based on azimuth angle data collected within 8 s according to the present disclosure;

FIG. 4 shows a flowchart of determining whether a to-be-identified turning event is a turning event based on acceleration data according to the present disclosure;

FIG. 5(a) to FIG. 5(d) show a schematic representation of a motion characteristic value of acceleration data collected when a turning event or a non-turning event occurs according to the present disclosure;

FIG. 6 shows a schematic flowchart of judging a preset motion turning condition according to the present disclosure;

FIG. 7 shows a schematic flowchart of judging a preset non-motion turning condition according to the present disclosure;

FIG. 8 shows a flowchart of an embodiment of a positioning method according to the present disclosure;

FIG. 9 shows a schematic diagram of the structure of an embodiment of a positioning device according to the present disclosure;

FIG. 10 shows a schematic diagram of the structure of another embodiment of a positioning device according to the present disclosure;

FIG. 11 shows a schematic diagram of the structure of an embodiment of a positioning device according to the present disclosure;

FIG. 12 shows a schematic diagram of the structure of an embodiment of an electronic device according to the present disclosure; and

FIG. 13 shows a structural schematic diagram of an embodiment of a positioning server according to the present disclosure.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

In order to enable a person skilled in the art to better understand the present disclosure, the technical solutions of the embodiments of the present disclosure will be clearly and completely described in connection with the accompanying drawings in the embodiments of the present disclosure

In some of the flows described in the description, claims and accompanying drawings of the present disclosure, a number of operations occurring in a particular order are included, however, it should be clear that these operations may not be performed in the order as they appear herein, or they may be performed in parallel. The sequence numbers of operations such as 101, 102 are merely used to distinguish different operations, and the sequence numbers themselves do not represent any order of execution. In addition, these flows may include more or fewer operations, and these operations may be performed sequentially or in parallel. It should be noted that the terms such as “first”, “second” herein are used to distinguish different messages, devices, modules, etc., and do not represent a sequential order or define that “first” and “second” are different types.

The positioning method according to the present disclosure can be applicable to, but not limited to, application scenarios such as map positioning and the like.

At present, the wearable device mainly uses the built-in positioning instrument to obtain at intervals of time the longitude and latitude values of the user at the current moment by using the GPS, WIFI or base station. The longitude and latitude values acquired are used as positioning points, and the positioning points obtained at adjacent moments are linearly connected to obtain the motion trajectory of the user and display on the map. However, due to the intervals of time, it cannot be guaranteed that the position of the turning point at the turning moment of the user can be collected and used for positioning. Thus, when two adjacent positioning points are linearly connected, due to the fact that the turning points are not positioned, the motion trajectory displayed on the map directly traverses a building or traverses different blocks and the like, and the actual motion trajectory of the user cannot be truly reflected.

In order to solve the technical problem that the motion trajectory obtained by positioning cannot truly reflect the actual motion trajectory, the inventors conducted a series of studies and propose the technical solutions of the present disclosure. According to the present disclosure, the azimuth angle data collected by the first sensor and the acceleration data collected by the second sensor are acquired respectively. It is judged whether a turning event occurs at a current moment based on the azimuth angle data and the acceleration data. If a turning event occurs, a positioning request is generated to acquire position data of the current moment based on the positioning request for positioning and displaying. According to the embodiments of the present disclosure, the positional change caused by a turning action is identified and positioned, so that the motion trajectory displayed on the map reflects the actual movement more truly.

The technical solutions according to the present disclosure will be described in detail below in conjunction with the accompanying drawings.

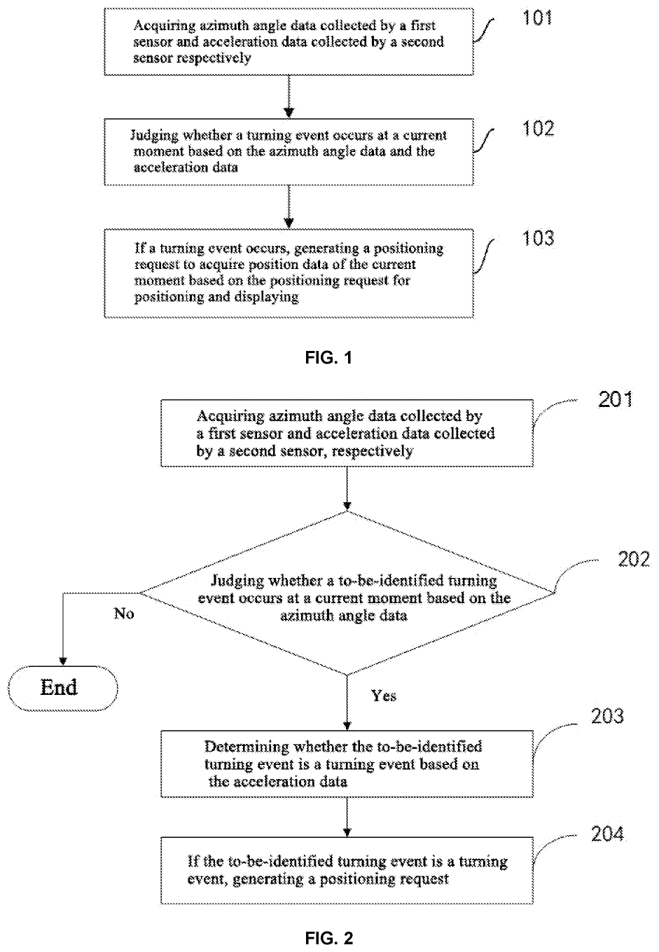

FIG. 1 is a flowchart of an embodiment of a positioning method according to an embodiment of the present disclosure. The method may comprise:

101: acquiring azimuth angle data collected by a first sensor and acceleration data collected by a second sensor respectively.

In practical applications, the positioning method may be applied to wearable devices. The first sensor may be a G-sensor (gyroscope sensor), which may be a three-axis gyroscope for collecting sub-azimuth angle data of the x-axis, y-axis, and z-axis, respectively. The azimuth angle data of the actual shift at the current moment can be calculated by Kalman filtering based on the sub-azimuth angle data of the three axes collected respectively; the azimuth angle data is the yaw angle caused by the orientation shift during the movement of the user, and its unit is °/s (i.e., degrees/sec). In practical applications, the method for calculating the yaw angle includes, but is not limited to, the Kalman filtering calculation method. Other existing technologies may also be used to calculate the yaw angle of the present disclosure, which will not be described in detail herein.

In practical applications, the second sensor may be an A-sensor (accelerometer sensor), which may be a three-axis accelerometer for collecting sub-acceleration data of the x-axis, y-axis, and z-axis, respectively. The acceleration data at the current moment is calculated based on the sub-acceleration data collected respectively. The acceleration data is actually the actual motion acceleration during the movement of the user, and the motion state at the current moment of the user can be determined based on the change of the motion acceleration. For example, when the acceleration is 0, it is a static state; when the acceleration is small, it is slow walking; when the acceleration is great, it is fast walking or running, etc. The unit of acceleration data is g (9.8 m²/s).

In practical applications, regarding the calculation process of the azimuth angle data and the acceleration data, the data can be obtained through a six-axis fusion algorithm after Kalman filtering based on the data collected by the A-sensor and G-sensor. The six-axis fusion algorithm is a common technique, and is not described in detail herein.

102: judging whether a turning event occurs at a current moment based on the azimuth angle data and the acceleration data.

The gyroscope sensor can measure the change in azimuth angle during the movement of the user. However, during the movement of the user, the non-turning events (such as, an in-situ turning, stopping after turning, or shaking after turning) that often occur also cause the change of azimuth angle, although the geographic position of the user does not actually change. If the positioning is frequently performed under such situation, the power consumption of the positioning device is too large, and there is no practical significance to do so. At this time, it is impossible to judge a normal turning event only by the change of azimuth angle. In order to avoid frequent positioning with respect to non-turning events and reduce system power consumption, the motion state of the user within a certain preset time (e.g., within the current 8 s) can be further judged based on the acceleration data collected by the second sensor, then the non-turning events caused by the change of azimuth angle are filtered out based on the motion state, only the normal turning events are positioned, and thus the positioning accuracy is greatly improved while the power consumption of the system is reduced.

103: if a turning event occurs, generating a positioning request to acquire position data of the current moment based on the positioning request for positioning and displaying.

A positioning request is generated when it is determined that a turning event occurs at the current moment. The positioning request may be sent to a positioning device of the wearable device, the position data of the current moment is acquired by a positioning device such as GPS, WiFi and the like, and the positioning and displaying are performed based on the acquired position data.

In practical applications, after the positioning points determined based on the position data are sent to the server end, a motion trajectory is generated at the server end based on the positioning points, and the motion trajectory is sent to the terminal device for displaying. Of course, if the positioning is performed by the server end, the positioning request may be sent to the positioning server, the positioning server obtains the position data of the current moment based on the positioning request and performs positioning, and sends the motion trajectory determined by the positioning points based on the position data acquired when a turning event occurs to the wearable device to display in the map of the wearable device.

It will be appreciated that the present disclosure is implemented on the basis of the existing positioning method in which the longitude and latitude on the earth of the user at the current moment obtained by GPS, WiFi, or base station at intervals of time. Therefore, the positioning device or the positioning server itself will obtain the position data of the user at intervals of time, and after receiving the positioning request generated based on the turning event, the position data of the turning event is obtained, so that the motion trajectory of the user can be determined based on the position data acquired at intervals of time and the positioning data acquired when a turning event occurs, so that the motion trajectory displayed on the map can reflect the actual movement more truly.

In the embodiments of the present disclosure, the azimuth angle data and the acceleration data when the user moves are collected, and it is judged whether a turning event occurs at the current moment based on the collected azimuth angle data and the acceleration data. By identifying and positioning the positional change caused by a turning action, the positioning points of the position of the turning point during the movement of the user are obtained, so that the motion trajectory displayed on the map reflects the actual movement more truly.

Optionally, in some embodiments, if a turning event occurs, generating a positioning request to acquire position data of the current moment based on the positioning request for positioning and displaying comprises: if a turning event occurs, generating a positioning request; sending the positioning request to a server end to enable the server end to acquire position data of a current moment based on the positioning request; generating a motion trajectory based on positioning points determined by the position data; and outputting the motion trajectory generated by the server end in a map.

In practical applications, if the positioning is performed at the server end, the generated positioning request needs to be sent to the server end, and the server end acquires the position data at the current moment in time based on the positioning request and uses it as a positioning point. When the motion trajectory is generated at the server end, the motion trajectory includes positioning points corresponding to the position data when the turning event occurs, so that the motion trajectory generated at the server end can reflect the movement of the user more truly. With the actual movement of the user, the motion trajectory can also be updated in real time as the position of the user changes so as to display the real movement of the user in real time in the map of the wearable device.

FIG. 2 is a flowchart of yet another embodiment of a positioning method according to an embodiment of the present disclosure. The method may comprise:

201: acquiring azimuth angle data collected by a first sensor and acceleration data collected by a second sensor, respectively.

202: judging whether a to-be-identified turning event occurs at a current moment based on the azimuth angle data.

Optionally, in some embodiments, determining whether a to-be-identified turning event occurs at the current moment based on the azimuth angle data comprises: calculating an angle difference between a first azimuth angle data collected at a start moment in a preset time range and a second azimuth angle data collected at an end moment in the preset time range; determining whether the angle difference is greater than an angle threshold; and if the angle difference is greater than the angle threshold, determining that the to-be-identified turning event occurs at the current moment.

In practical applications, the first sensor and the second sensor are used for collecting azimuth angle data and acceleration data in real time. The sampling frequency may be 26 Hz, and the collected data may be processed every 8 seconds. Therefore, the preset time range may be set to collect the data within the current 8 s. After collecting the azimuth angle data within the current 8 s, it is judged whether a turning event occurs at the current moment based on the angle difference between the first azimuth angle data collected at the first second within the current 8 s and the second azimuth angle data collected at the current moment (i.e., the 8th second). Theoretically, when a user walks outdoors, a 90° yaw angle change will occur at the intersection of the road, and a 180° yaw angle change will occur when the user moves in the reverse direction. Thus, in the embodiments of the present disclosure, the angle threshold may be set to 50°, and as long as the yaw angle changes by more than 50°, it can be considered that a to-be-identified turning event occurs.

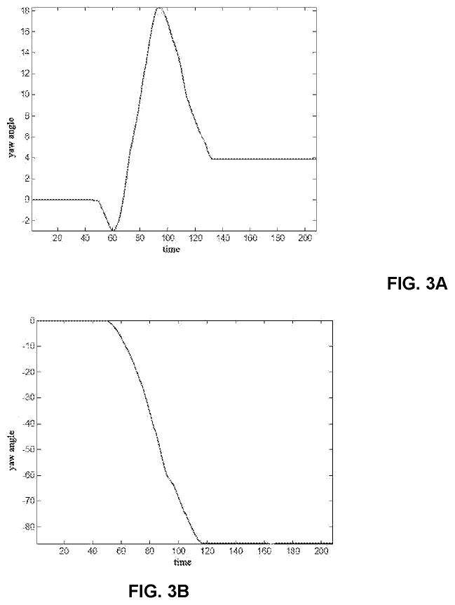

FIG. 3 (a) and FIG. 3 (b) show azimuth angle data collected in a period of 8 s. Since the sampling frequency of the first sensor is 26 Hz, 208 data is collected in 8 s. As shown in FIG. 3 (a), the first azimuth angle data collected at the start moment is 0°, the second azimuth angle data collected at the end moment is 4°, it is identified that the azimuth angle changes during the movement of the user, and the azimuth angle change in the 8 s is 4°, so it can be determined that the azimuth angle change is not a to-be-identified turning event. As shown in FIG. 3 (b), it is identified that the azimuth angle changes during the movement of the user, and the azimuth angle change in the 8 s is close to 90°, so it can be determined that a to-be-identified turning event occurs.

It will be appreciated that the first preset time can be set according to the actual situation, for example, in order to further improve the calculation accuracy, the time required for the actual turning of the user can be judged according to different movement speeds and motion states of the user, and it is taken as the first preset time. Of course, the first preset time may also be determined according to the operation efficiency and the data collection speed.

Similarly, the angle threshold may be set according to actual accuracy requirements, and is not specifically limited herein.

203: if a to-be-identified turning event occurs, determining whether the to-be-identified turning event is a turning event based on the acceleration data.

204: if the to-be-identified turning event is a turning event, generating a positioning request to acquire position data of the current moment based on the positioning request for positioning and displaying.

In an alternative embodiment, if a to-be-identified turning event occurs, determining whether the to-be-identified turning event is the turning event based on the acceleration data comprises: determining a motion state and a motion characteristic value corresponding to the to-be-identified turning event based on the acceleration data; judging whether the motion state is of a motion type or a non-motion type; if the motion state is of a motion type, determining that the to-be-identified turning event is the turning event when the motion characteristic value satisfies a preset motion turning condition; and if the motion state is of a non-motion type, determining that the to-be-identified turning event is the turning event when the motion characteristic value satisfies a preset non-motion turning condition.

In practical applications, after determining the to-be-identified turning event based on the azimuth angle data, the motion state of the user can be further classified based on the acceleration data collected by the second sensor. In the embodiments of the present disclosure, the motion state in which a person actively moves and a displacement is caused is defined as a motion type; the motion state in which a person passively moves and a displacement is caused and the motion state in which a person actively moves but no displacement is caused are defined as a non-motion type. For example, the motion states of a user such as walking (fast walking, slow walking) and running are marked as the motion type; the motion states in other travel processes of the user, such as piaffe without moving forward, riding, are marked as the non-motion type. Meanwhile, by processing the acceleration data, motion characteristic values (such as the standard deviation (Std), the kurtosis, the ratio of the standard deviation to the kurtosis, and the fluctuation) of the acceleration data collected in the preset time can be calculated.

In the practical applications, it is known in the art to determine the current motion state by using the acceleration data and obtain the motion characteristic value by performing processing on the acceleration data using methods such as Kalman filtering. In the embodiments of the present disclosure, the motion characteristic value and the motion state can be calculated based on the acceleration data by conventional calculation methods, which will not be described in detail herein.

The actual preset motion turning condition and preset non-motion turning condition can be set according to the actual accuracy requirement. In the embodiments of the present disclosure, they are determined by the inventors after a great number of tests, and processing, analyses and statistics on the acceleration data collected when the to-be-identified turning event occurs under different conditions, and the identification rate of the turning event in the to-be-identified turning event satisfies the system accuracy requirement. The specific analysis process is as follows.

In theory, the standard deviation can reflect the fluctuation of the waveform, the kurtosis can reflect the sharpness of the waveform, the fluctuation is the ratio of the maximum value and the minimum value in the fluctuation mean value of each second within a preset time (e.g., within 8 s) and can reflect the stability of the waveform.

During actual movement, if the user turns and then moves near the original place, the change in motion state will occur before and after the user turns. Therefore, by first judging whether the motion state changes, and then judging whether the motion characteristic value changes, it can be better judged whether the to-be-identified turning event is a turning event.

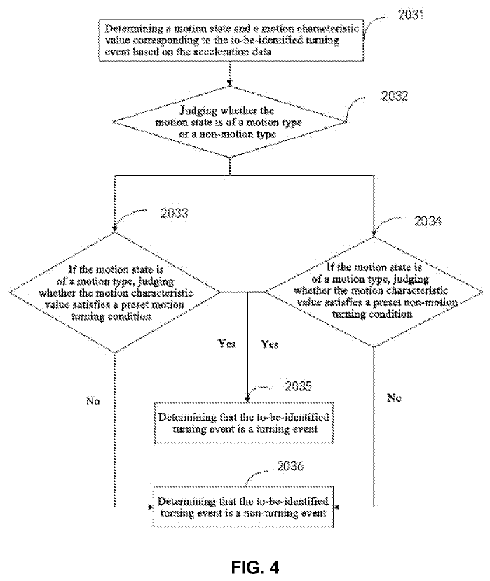

As shown in FIG. 4, the step 203, i.e., if a to-be-identified turning event occurs, determining whether the to-be-identified turning event is a turning event based on the acceleration data, may comprise the following sub-steps:

2031: determining a motion state and a motion characteristic value corresponding to the to-be-identified turning event based on the acceleration data;

2032: judging whether the motion state is of a motion type or a non-motion type;

2033: if the motion state is of a motion type, judging whether the motion characteristic value satisfies a preset motion turning condition; if yes, executing step 2035, and if no, executing step 2036;

2034: if the motion state is of a motion type, judging whether the motion characteristic value satisfies a preset non-motion turning condition; if yes, executing step 2035, and if no, executing step 2036;

2035: determining that the to-be-identified turning event is the turning event.

2036: determining that the to-be-identified turning event is the non-turning event.

The inventors have discovered through a large number of experiments that the reaction of a turning event and a non-turning event in the to-be-identified turning events on the acceleration data is different. Take the acceleration data collected in 8 s as an example, the motion state of the user remains substantially consistent before and after a normal turning event occurs, which can reflect on the motion characteristic value. The standard deviation, the kurtosis, the ratio of the standard deviation to the kurtosis, and the fluctuation of the acceleration data within the current 8 s are substantially consistent with the motion characteristic values within the previous and subsequent 8 s. But the motion state before and after a non-turning event will change, and the motion characteristic value within the current 8 s (at least one of the standard deviation, the ratio of the standard deviation to the kurtosis, and the fluctuation of the acceleration data) change, and even change irregularly, compared with the motion characteristic values within the previous and subsequent 8 s. Accordingly, a non-turning event may be further filtered out by judging a combined feature of the at least one motion feature described above.

Since in different motion states, the motion characteristic values show different characteristics, so the motion state of the user within the current 8 s must be distinguished first. The motion state can be represented by the motion state value. For example, when the motion state is the non-motion type, the motion state value is represented as 1; when the motion state is the motion state, the motion state value is represented as 2.

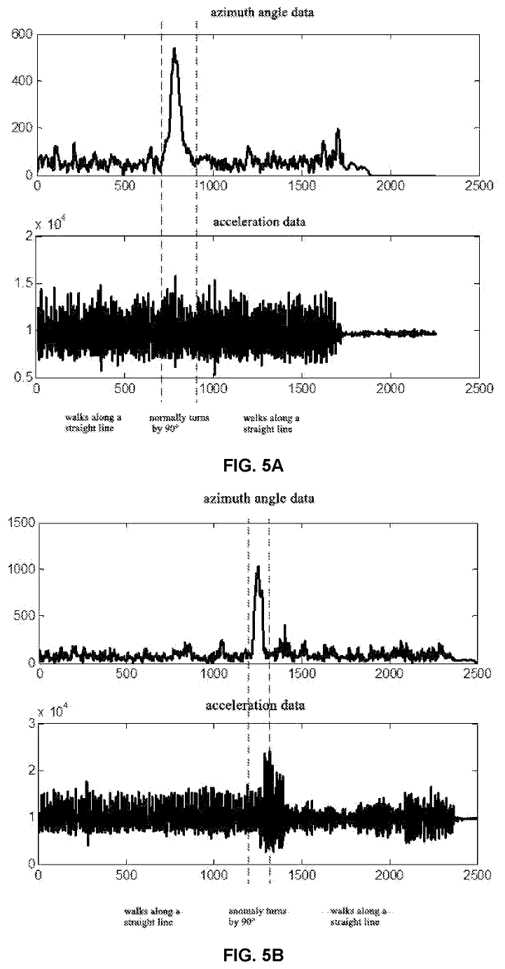

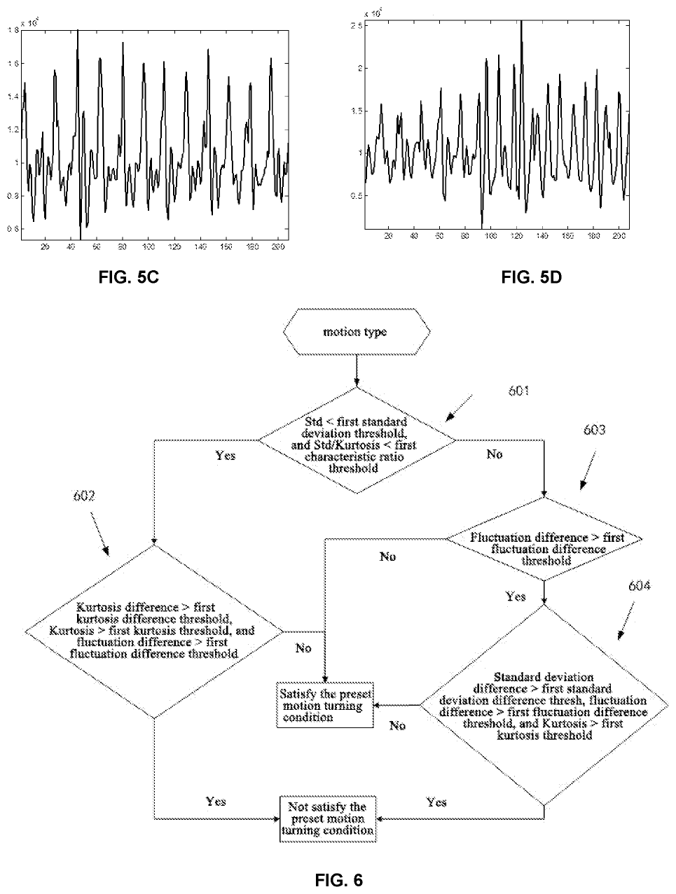

FIG. 5 (a) shows a turning event corresponding to that, in 8 s, the user walks along a straight line for a while, then turns by 90°, changes the azimuth angle and continues to walks along a straight line. As can be seen from FIG. 5 (a), the amplitude, peak, and fluctuation of the corresponding acceleration data are almost consistent before and after the azimuth angle changes. FIG. 5 (b) shows a non-turning event corresponding to that, in 8 s, the user walks along a straight line for a while, then turns by 90°, changes the azimuth angle and irregularly shakes in the original place. As can be seen from the FIG. 5 (b), the amplitude, peak and fluctuation of the corresponding acceleration data change greatly before and after the azimuth angle changes.

FIG. 5 (c) and FIG. 5 (d) show the acceleration data corresponding to the turning event and the non-turning event collected when in 8 s, the user walks along a straight line for a while and then turns by 90°. After comparison, it can be seen that, in the acceleration data corresponding to the non-turning event, compared with the turning event, the waveform amplitude changing range is greater, the fluctuation is more irregular, the waveform is sharper, the stability is poor, and it is easier to distinguish. However, it is difficult to distinguish based on the azimuth angle data collected by the gyroscope sensor.

As can be seen from the above, the non-turning event in the to-be-identified turning event can be effectively filtered out based on the stability of the motion characteristic value of the acceleration data collected before and after the to-be-identified turning event occurs.

Table 1 shows, when a turning event corresponding to FIG. 5 (a) occurs, the motion characteristic values of the acceleration data collected when turning by 90° within the current 8 s, and the motion characteristic values of the acceleration data collected within the adjacent previous three 8 s and subsequent three 8 s. Table 2 shows, when a non-turning event corresponding to FIG. 5 (b) occurs, the motion characteristic values of the acceleration data collected when turning by 90° within the current 8 s, and the motion characteristic values of the acceleration data collected within the adjacent previous three 8 s and subsequent three 8 s.

As can be seen from Table 1 and Table 2, the motion state of the user has not changed before and after the actual to-be-identified turning event occurs, and the motion state values are all 2. Therefore, the non-turning events cannot be filtered out based on the change of the motion state. However, after comparison, it can be seen that, compared with the characteristic values of the acceleration data collected in the adjacent previous three 8 s and the subsequent three 8 s, the characteristic values of the acceleration data collected in 8 s at the moment when the non-turning event occurs (as shown in the grey area in Table 2) all changes greatly in the standard deviation, kurtosis, the ratio of standard deviation to kurtosis, and fluctuation; on the other hand, compared with the characteristic values of the acceleration data collected in the adjacent previous three 8 s and the subsequent three 8 s, the characteristic values of the acceleration data collected in 8 s at the moment when the turning event occurs (as shown in the grey area in Table 1) do not change greatly in the standard deviation, kurtosis, the ratio of standard deviation to kurtosis, and fluctuation.

As can be seen from the above, when the non-turning events cannot be filtered out through the motion state, the non-turning events can be further filtered out through the difference between the characteristic values of the acceleration data collected in 8 s corresponding to the moment when a turning action occurs and the characteristic values of the acceleration data collected at the previous steady motion moment.

In order to eliminate the difference in the result caused by the occasionality of data collection, the mean value of the characteristic values of the acceleration data collected at the steady motion moment within the closest three 8 s to the current 8 s may be used to compare with the motion characteristic values of the current 8 s.

It is found by studies that the standard deviation of the acceleration data collected within 8 s varies in different circumstances. For example, when the time in which the user turns and then moves slowly (e.g., shaking or pacing up and down) near the original place is relatively long in the 8 s, the corresponding standard deviation will decrease than before; if the time is short, the variation in the standard deviation will be relatively small. If the user turns and then moves around near the original place for a long time, the corresponding standard deviation will increase. Thus, in different circumstances, the standard deviation mean value of the acceleration data of the adjacent previous three 8 s and the standard deviation of the acceleration data of the current 8 s may be a positive value or a negative value, but both are abnormal turning events. Thus, when the judgment is performed, the absolute value of the standard deviation may be used.

As shown in Table 3, after performing near 900 tests and statistics on the data collected with respect to the to-be-identified turning event, the inventors find that when the turning events occur, a high proportion of the corresponding user motion states are of the motion type; it is opposite for the non-turning events. Therefore, when the to-be-identified turning event is judged, if the user motion state within the current 8 s is of the motion type, it is very likely that a turning event occurs. In order to avoid false identification and identify the turning event as accurate as possible, a more stringent turning condition than for the non-motion type must be set.

TABLE 3

| | | Motion state | | |
|---|---|---|---|---|
| To-be-identified | Number | within the | Number | Percentage |
| turning event | of tests | current 8s | of times | (100%) |
| Turning event | 450 | Non-motion type | 83 | 22.6 |
| | | Motion type | 367 | 77.4 |
| Non-turning | 450 | Non-motion type | 353 | 78.4 |
| event | | Motion type | 97 | 21.6 |

Thus, with respect to the motion state of the user, different types of turning conditions may be set, as shown in FIG. 4. That is, if it is determined that the to-be-identified turning event corresponds to a motion state, it is necessary to judge whether the corresponding motion characteristic value within the current 8 s satisfies a preset motion turning condition. If it is determined that the to-be-identified turning event corresponds to a non-motion state, it is necessary to determine whether the corresponding motion characteristic value within the current 8 s satisfies a preset non-motion turning condition.

Alternatively, as an implementable embodiment, the motion characteristic value may include:

one or more of a standard deviation, a kurtosis, a characteristic ratio of the standard deviation to the kurtosis, a kurtosis difference, a fluctuation difference and a standard deviation difference of the acceleration data collected within a current preset time period;

wherein the kurtosis difference is a difference between a kurtosis of the acceleration data collected within the current preset time period and a kurtosis mean value of at least one previous preset time period adjacent to the current preset time period;

the fluctuation difference is a difference between a fluctuation value of the acceleration data collected within the current preset time period and the fluctuation mean value of at least one previous preset time period adjacent to the current preset time period; and

the standard deviation difference is an absolute difference between a standard deviation of the acceleration data collected within the current preset time period and a standard deviation mean value of at least one previous preset time period adjacent to the current preset time period.

It can be understood that the at least one preset time period may be set according to actual situations. For example, the previous two preset time periods or the previous three preset time periods, etc. are selected, which is not specifically limited herein.

In an alternative embodiment, if the motion state is of a motion type, judging whether the to-be-identified turning event is the turning event according to whether the motion characteristic value satisfies a preset motion turning condition may comprise:

if the motion state is of a motion type, determining whether the motion characteristic value satisfies a preset motion turning condition;

if yes, determining that the to-be-identified turning event is the turning event;

if no, determining that the to-be-identified turning event is the non-turning event.

In an alternative embodiment, if the motion state is of a non-motion type, judging whether the to-be-identified turning event is the turning event according to whether the motion characteristic value satisfies a preset non-motion turning condition may comprise:

determining whether the motion characteristic value satisfies a preset non-motion turning condition if the motion state is of a non-motion type;

if yes, determining that the to-be-identified turning event is the turning event;

if no, determining that the to-be-identified turning event is the non-turning event.

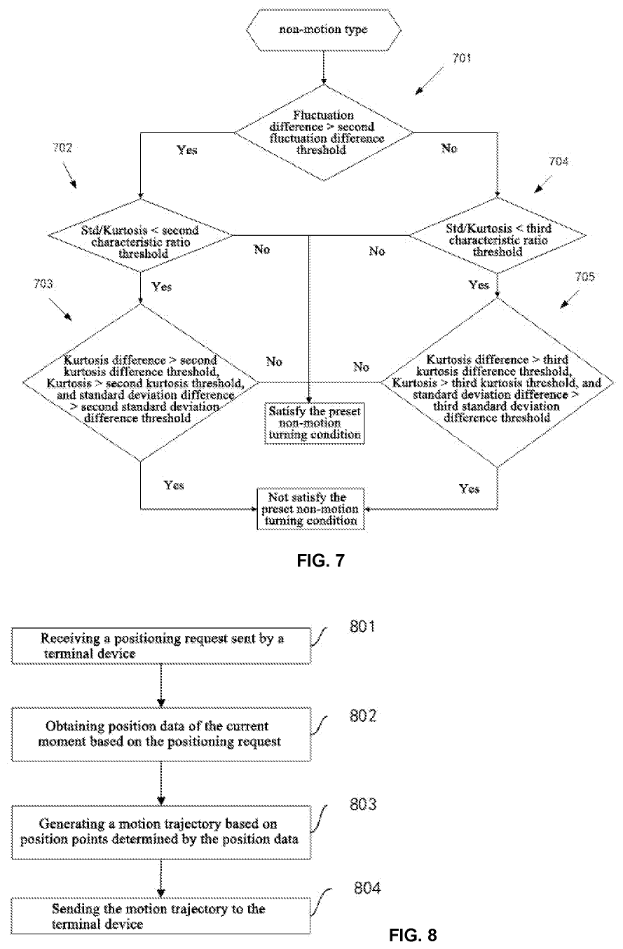

As can be seen from the foregoing, the motion characteristic value when the motion state of the user is of the motion type has a different representation from that when the motion state of the user is of the non-motion type. Therefore, a preset motion turning condition (as shown in FIG. 6) and a preset non-motion turning condition (as shown in FIG. 7) are set to improve the identification rate of the user when a turning event occurs in different motion states.

In FIG. 6 and FIG. 7, the Std represents the standard deviation, Kurtosis represents the kurtosis, the Std/Kurtosis represents the characteristic ratio, the kurtosis difference can be expressed as the kurtosis of the current preset time period minus the mean value of the kurtoses of the adjacent previous three preset time periods, and the standard deviation difference can be expressed as abs|the Std of the current preset time period minus the mean value of the Std of the adjacent previous three preset time periods|.

FIG. 6 shows a schematic flowchart of a judging process of a corresponding preset motion turning condition when a to-be-identified turning event is of a motion type. The step of, if the motion state is of a motion type, determining that the to-be-identified turning event is the turning event when the motion characteristic value satisfies a preset motion turning condition comprises:

if the motion state is of a motion type, judging whether the standard deviation is less than a first standard deviation threshold and whether the characteristic ratio is less than a first characteristic ratio threshold;

if the standard deviation is less than the first standard deviation threshold and the characteristic ratio is less than the first characteristic ratio threshold, and at the same time, the kurtosis difference is less than or equal to a first kurtosis difference threshold, and/or the kurtosis is less than or equal to a first kurtosis threshold, and/or the fluctuation difference is less than or equal to a first fluctuation difference threshold, determining that the motion characteristic value satisfies the preset motion turning condition, and determining that the to-be-identified turning event is the turning event;

if the standard deviation is greater than or equal to the first standard deviation threshold, and/or the characteristic ratio is greater than or equal to the first characteristic ratio threshold, further judging whether the fluctuation difference is greater than the first fluctuation threshold;

if the fluctuation difference is greater than the first fluctuation threshold, and at the same time, the standard deviation difference is less than or equal to a first standard deviation difference threshold, and/or the kurtosis difference is less than the first kurtosis difference threshold, and the kurtosis is less than or equal to the first kurtosis threshold, determining that the motion characteristic value satisfies the preset motion turning condition;

if the fluctuation difference is less than or equal to the first fluctuation threshold, determining that the motion characteristic value satisfies the preset motion turning condition, and determining that the to-be-identified turning event is the turning event.

In practical applications, the first standard deviation threshold, the first characteristic ratio, the first kurtosis difference threshold, the first fluctuation difference threshold, the first fluctuation threshold and the first standard deviation difference threshold are all determined through a great number of tests and statistics, and satisfy the identification accuracy requirement of the system.

When a non-turning event occurs, the motion state of the user will change. At this time, the waveform of the acceleration data collected by the accelerometer sensor will show more chaotic and sharp peaks, and the change of the characteristic ratio within the current 8 s is also obvious. It is found by statistics that the turning event and the non-turning event in the to-be-identified turning events can be well identified when the Std/Kurtosis is less than the first characteristic ratio threshold, but when the user walks slowly and a normal turning event occurs, the Std/Kurtosis is less than the first characteristic ratio threshold and at the same time the Std is less than the first standard deviation threshold. But since these are merely statistical empirical values, the possibility of identifying a non-turning event as a turning event and identifying a turning event as a non-turning event based on the above conditions may still exist. In order to further reduce false identification rates, more turning events are retained, so that the analysis of kurtosis and fluctuation are increased. As can be seen in Table 1 and Table 2, when a non-turning event and a turning event occur, the performance of the motion characteristic values, in particular the fluctuation difference, the kurtosis difference and the standard deviation difference, are different, so they can be used to better distinguish the non-turning event and the turning event. It is found by statistics of a large amount of test data that, when it is used as the judgment condition that the kurtosis difference within the current 8 s is greater than the first kurtosis difference threshold, and the Kurtosis is greater than the first kurtosis threshold, and the fluctuation difference is greater than the first fluctuation difference threshold, the non-turning events in the to-be-identified turning event can be effectively filtered out and the turning events are retained. Table 4, Table 5, and Table 6 below show test data obtained by performing tests on a large amount of data under the aforementioned condition and the failed identification rates when performing identification based on the foregoing condition.

Table 4 shows a statistical result of identification based on a motion characteristic value of a to-be-identified turning event in FIG. 6. As stated above, the judgment condition 601 in FIG. 6 (that is, the motion characteristic values satisfy that the Std/Kurtosis is less than the first characteristic ratio threshold and at the same time the Std is less than the first standard deviation threshold) can effectively identify the normal turning event of the user when the user walks slowly. As can be seen from Table 4, the judgment condition 601 can identify a majority of the turning event, and the identification probability is 37/51; on the other hand, the statistical probability of the non-turning events satisfying the judgment condition is 131/235. Therefore, in order to filter out more non-turning events and retain more turning events, as stated above, the fluctuation difference and kurtosis difference can be used to better distinguish the non-turning events and turning events. As can be seen from Table 4, the judgment condition 602 can reduce the false identification rate of the non-turning event to 10/131, and reduce the false identification rate of the turning event to 5/37, so that the identification accuracy requirement of the system is met.

At the same time, it can be seen from Table 4 that, when the differences and the characteristic ratio of the turning event satisfy that the Std is less than the first standard deviation threshold and the Std/Kurtosis is greater or equal to the first characteristic ratio threshold, none of the fluctuation differences satisfies the judgment condition that the fluctuation difference is greater than 40; on the other hand, the ratio of the non-turning events satisfying the judgment condition is 83/104. Thus, the judgment conditions 601-603 can be used to retain all of the turning events satisfying the judgment condition, and filtering out most non-turning events. At the same time, considering that there is still 18 items of test data in the non-turning events that are falsely identified as a turning event, it needs to further add a judgment condition to reduce the false identification rate. As stated above, the standard deviation difference can effectively distinguish the turning event and the non-turning event, so a judgment condition 604 that the standard deviation difference is greater than 400 is added to further reduce the false identification rate of the system.

As can be seen from FIG. 5 and FIG. 6, after the judgment condition 604 is added, the false identification probability of the turning event is reduced to 0, and the false identification probability of the non-turning event is also greatly reduced.

TABLE 4

| | | | | | Kurtosis difference > | Fluctuation | | |
|---|---|---|---|---|---|---|---|---|
| | | Std < first | | | first kurtosis difference | difference > first | | |
| | | standard | Std/Kurtosis < | | threshold, and | fluctuation | | False |
| | Number | deviation | first characteristic | Number | Kurtosis > first kurtosis | difference | Number | identification |
| | of tests | threshold | ratio threshold | of tests | threshold | threshold | of times | rate |
| Turning | 51 | Yes | Yes | 37 | Yes | Yes | 5 | 5/37 |
| event | | | | | Yes | No | 3 | |
| | | | | | No | Yes | 1 | |
| | | | | | No | No | 26 | |
| | | | No | 14 | Yes | Yes | 0 | 0 |
| | | | | | Yes | No | 8 | |
| | | | | | No | Yes | 0 | |
| | | | | | No | No | 6 | |
| Non- | 235 | Yes | Yes | 131 | Yes | Yes | 82 | 10/131 |
| turning | | | | | Yes | No | 23 | |
| event | | | | | No | Yes | 11 | |
| | | | | | No | No | 10 | |
| | | | No | 104 | Yes | Yes | 82 | 83/104 |
| | | | | | Yes | No | 1 | |
| | | | | | No | Yes | 18 | |
| | | | | | No | No | 3 | |

TABLE 5

| | | | | | | | | Kurtosis | Standard | | |
|---|---|---|---|---|---|---|---|---|---|---|---|
| | | | | | | | | difference > | deviation | | |
| | | | Std/ | | Fluctuation | | | first kurtosis | difference > | | |
| | | Std < | Kurtosis < | | difference > | | | difference | first | | |
| | | first | first | | first | | | threshold, and | standard | | |
| | | standard | characteristic | | fluctuation | Number | Failed | Kurtosis > first | deviation | Number | False |
| | Number | deviation | ratio | Number | difference | of | identification | kurtosis | difference | of | identification |
| | of tests | threshold | threshold | of tests | threshold | times | rate | threshold | thresh | times | rate |
| Turning | 46 | Yes | No | 14 | Yes | 3 | 3/14 | | | | |
| event | | | | | No | 11 | | | | | |
| | | No | Yes | 9 | Yes | 3 | 1/3 | Yes | Yes | 0 | 0 |
| | | | | | | | | Yes | No | 1 | |
| | | | | | | | | No | Yes | 1 | |
| | | | | | | | | No | No | 1 | |
| | | | | | No | 6 | | | | | |
| | | | No | 23 | Yes | 7 | 7/23 | Yes | Yes | 2 | 2/23 |
| | | | | | | | | Yes | No | 1 | |
| | | | | | | | | No | Yes | 2 | |
| | | | | | | | | No | No | 2 | |
| | | | | | No | 16 | | | | | |

TABLE 6

| | | | | | | | | Kurtosis | | | |
|---|---|---|---|---|---|---|---|---|---|---|---|
| | | | | | | | | difference > | Standard | | |
| | | | | | Fluctuation | | | first kurtosis | deviation | | |
| | | | | | difference > | | | difference | difference > | | |
| | | Std < first | Std/Kurtosis < | | first | | | threshold, and | first | | |
| | | standard | first | | fluctuation | | Failed | Kurtosis > first | fluctuation | | False |
| | Number | deviation | characteristic | Number | difference | Number | identification | kurtosis | difference | Number | identification |
| | of tests | threshold | ratio threshold | of tests | threshold | of times | rate | threshold | threshold | of times | rate |
| Non- | 222 | Yes | No | 104 | Yes | 100 | 1/25 | Yes | Yes | 47 | 8/104 |
| turning | | | | | | | | Yes | No | 37 | |
| event | | | | | | | | No | Yes | 13 | |
| | | | | | | | | No | No | 4 | |
| | | | | | No | 4 | | | | | |
| | | No | Yes | 75 | Yes | 74 | 1/75 | Yes | Yes | 36 | 5/75 |
| | | | | | | | | Yes | No | 22 | |
| | | | | | | | | No | Yes | 12 | |
| | | | | | | | | No | No | 4 | |
| | | | | | No | 1 | | | | | |
| | | | No | 43 | Yes | 43 | 0 | Yes | Yes | 25 | 2/43 |
| | | | | | | | | Yes | No | 10 | |
| | | | | | | | | No | Yes | 6 | |
| | | | | | | | | No | No | 2 | |
| | | | | | No | 0 | | | | | |

Therefore, according to the above analysis and statistics, the first standard deviation threshold, the first characteristic ratio threshold, the first kurtosis difference threshold, the first kurtosis threshold, the first fluctuation difference threshold and the first standard deviation difference threshold can be set according to actual needs, as long as the false identification rate of the to-be-identified turning event finally meet the preset requirement, which is not specifically limited herein. One or a combination of more than one threshold condition corresponding to the aforementioned motion characteristic values constitutes a preset motion turning condition. The actual preset motion turning condition is not limited to the combination of the threshold conditions and the preset conditions, and can be adjusted according to actual needs. When the system accuracy needs to be further improved, by modifying the threshold conditions of different motion characteristic values and effectively combining the threshold conditions of motion characteristic values to carry out many tests and statistics, a preset motion turning condition with lower false identification rate can be further obtained, which is not specifically limited herein.

Similarly, as shown in FIG. 7, the step of, if the motion state is of a non-motion type, determining that the to-be-identified turning event is the turning event when the motion characteristic value satisfies a preset non-motion turning condition comprises:

if the motion state is of a non-motion type, determining whether the fluctuation difference is greater than a second fluctuation difference threshold;

if the fluctuation difference is greater than the second fluctuation difference threshold, further judging whether the characteristic ratio is less than a second characteristic ratio threshold;

if the characteristic ratio is less than the second characteristic ratio threshold, and at the same time, the kurtosis difference is less than or equal to a second kurtosis difference threshold, and/or the kurtosis is less than or equal to a second kurtosis threshold, and/or the standard deviation difference is less than or equal to a second standard deviation difference threshold, determining that the motion characteristic value satisfies the preset non-motion turning condition, and determining that the to-be-identified turning event is the turning event;

if the characteristic ratio is greater than or equal to the second characteristic ratio threshold, determining that the motion characteristic value satisfies the preset non-motion turning condition;

if the fluctuation difference is less than or equal to the second fluctuation difference threshold, further judging whether the characteristic ratio is less than a third characteristic ratio threshold;

if the characteristic ratio is less than the third characteristic ratio threshold, and at the same time, the kurtosis difference is less than or equal to a third kurtosis difference threshold, and/or the kurtosis is less than or equal to a third kurtosis threshold, and/or the standard deviation difference is less than or equal to a third standard deviation difference threshold, determining that the motion characteristic value satisfies the preset non-motion turning condition;

if the characteristic ratio is greater than or equal to the third characteristic ratio threshold, determining that the motion characteristic value satisfies the preset non-motion turning condition, and determining that the to-be-identified turning event is the turning event.

As stated above, the fluctuation can well measure the change of motion state of the user. According to the test and statistical results of Table 7, the fluctuation of the data waveform collected when a turning event occurs changes very little, and the fluctuation difference of most data waveforms is less than or equal to the second fluctuation difference threshold. That is, the probability that the motion state of the user changes is low when a turning event occurs, while the probability that the motion state of the user changes is high when a non-turning event occurs. Thus, the judgment condition 701 (that is, the fluctuation difference is greater than the first fluctuation difference threshold) can be used to identify most turning events and filter out most non-turning events. Table 8 and Table 9 show a statistical result of identification based on a motion characteristic value of a to-be-identified turning event in FIG. 7. It can be seen from Table 8 that the turning events whose characteristic ratio is less than the second characteristic ratio threshold (corresponding to the judgment condition 702 in FIG. 7) accounts for only a small part in the turning events, and the statistical probability of non-turning events reaches 73/74. That is, most non-turning events do not satisfy the judgment condition that the characteristic ratio is less than the second characteristic ratio threshold. In order to retain more turning events and reduce the false identification rate, a judgment condition 703 about kurtosis difference and standard deviation difference (that is, the kurtosis difference is greater than the second kurtosis difference threshold, and kurtosis is greater than the second kurtosis threshold, and standard deviation difference is greater than the second standard deviation difference threshold) is added. It can be seen from Table 8 that the false identification rate of turning events is reduced to 3/74, which is effectively controlled and meets the system accuracy requirements.

It can be seen from Table 9 that, the judgment condition that the characteristic ratio is less than the third characteristic ratio threshold (corresponding to the judgment condition 704 in FIG. 7) can effectively filter out non-turning events, but at the same time it filters out most turning events. Therefore, in order to further reduce the false identification rate, a judgment condition corresponding to 705 is added to further effectively distinguishes the turning events and non-turning events through the kurtosis difference and the standard deviation difference. It can be seen from Table 9 that the judgment conditions that the kurtosis difference is greater than the third kurtosis difference threshold, the kurtosis is greater than the third kurtosis threshold, and the standard deviation difference is greater than the third standard deviation difference threshold can effectively filter out non-turning events and effectively reduce the false identification rate of turning events to 9/293, which meets the system accuracy requirements.

TABLE 7

| | | Fluctuation difference > | |
|---|---|---|---|
| | Number of | second fluctuation | Number of |
| | tests | difference threshold | times |
| Turning event | 367 | Yes | 74 |
| | | No | 293 |
| Non-turning | 97 | Yes | 75 |
| event | | No | 22 |

TABLE 8

| | | | | | | Kurtosis | | | |
|---|---|---|---|---|---|---|---|---|---|
| | | | | | | difference > | Standard | | |
| | | | | | | second kurtosis | deviation | | |
| | Fluctuation | | | | | difference | difference > | | |
| | difference > | | | | | threshold, and | second | | |
| | second | | Characteristic | | | kurtosis > | standard | | |
| | fluctuation | | ratio < second | | Failed | second | deviation | | False |
| | difference | Number | characteristic | Number | identification | kurtosis | difference | Number | identification |
| | threshold | of times | ratio threshold | of times | rate | threshold | threshold | of times | rate |
| Turning | Yes | 74 | Yes | 21 | 21/74 | Yes | Yes | 3 | 3/74 |
| event | | | | | | Yes | No | 2 | |
| | | | | | | No | Yes | 5 | |
| | | | | | | No | No | 11 | |
| | | | No | 53 | | | | | |
| Non- | Yes | 75 | Yes | 74 | 1/75 | Yes | Yes | 38 | 2/75 |
| turning | | | | | | Yes | No | 19 | |
| event | | | | | | No | Yes | 16 | |
| | | | | | | No | No | 2 | |
| | | | No | 1 | | | | | |

TABLE 9

| | | | | | | Kurtosis | | | |
|---|---|---|---|---|---|---|---|---|---|
| | | | | | | difference > | Standard | | |
| | Fluctuation | | | | | third kurtosis | deviation | | |
| | difference > | | | | | difference | difference > | | |
| | second | | Characteristic | | | threshold, and | third standard | | |
| | fluctuation | | ratio < third | | Failed | kurtosis > third | deviation | | False |
| | difference | Number | characteristic | Number | identification | kurtosis | difference | Number | identification |
| | threshold | of times | ratio threshold | of times | rate | threshold | threshold | of times | rate |
| Turning | No | 293 | Yes | 135 | 135/293 | Yes | Yes | 60 | 3/293 |
| event | | | | | | Yes | No | 32 | |
| | | | | | | No | Yes | 34 | |
| | | | | | | No | No | 9 | |
| | | | No | 158 | | | | | |
| Non- | No | 22 | Yes | 20 | 1/11 | Yes | Yes | 8 | 2/11 |
| turning | | | | | | Yes | No | 5 | |
| event | | | | | | No | Yes | 4 | |
| | | | | | | No | No | 2 | |
| | | | No | 2 | | | | | |

As a result, according to the foregoing analysis and statistics, in the embodiments of the present disclosure, the second fluctuation difference threshold, the second characteristic ratio threshold, the third characteristic ratio threshold, the second kurtosis difference threshold, the second kurtosis threshold, the third kurtosis difference threshold, the third kurtosis threshold, the second standard deviation difference threshold and the third standard deviation difference threshold can be set according to actual needs, as long as the false identification rate of the to-be-identified turning event finally meet the preset requirement, which is not specifically limited herein. One or a combination of more than one threshold condition corresponding to the aforementioned motion characteristic values constitutes a preset non-motion turning condition. The actual preset non-motion turning condition is not limited to the combination of the threshold conditions and the preset conditions, and can be adjusted according to actual needs. When the system accuracy needs to be further improved, by modifying the threshold conditions of different motion characteristic values and effectively combining the threshold conditions of motion characteristic values to carry out many tests and statistics, a preset non-motion turning condition with lower false identification rate can be further obtained, which is not specifically limited herein.

In the embodiments of the present disclosure, the false identification rates are all statistical values, and the statistical results vary with the number of tests, test conditions, test environments, number of test items, etc. The embodiments of the present disclosure are only for providing reference for how to set the preset motion turning condition and the preset non-motion turning condition. The statistical results provided in the embodiments of the present disclosure are only exemplary, and not intended to limit the false identification rate of the system. The preset motion turning condition and the preset non-motion turning condition may be adjusted according to the actual situation, and are not specifically limited herein.

TABLE 10

| | | | False |
|---|---|---|---|
| | Number of | Scenario of | identification |
| Motion type | persons tested | turning events | rate |
| Slow walking | 50 | Turn by 90° | 2/50 |
| Slow walking | 50 | Turn by 120° | 5/50 |
| Slow walking | 50 | Turn by 180° | 1/50 |
| Walking | 50 | Turn by 90° | 3/50 |
| Walking | 50 | Turn by 120° | 2/50 |
| Walking | 50 | Turn by 180° | 4/50 |
| Running | 50 | Turn by 90° | 1/50 |
| Running | 50 | Turn by 120° | 2/50 |
| Running | 50 | Turn by 180° | 2/50 |
| Total number of | 450 | Total failed | 22/450 |
| persons tested | | identification rate | |

TABLE 11

| | Number | | False |
|---|---|---|---|
| | of persons | Scenario of non- | identification |
| Motion type | tested | turning events | rate |
| Slow walking | 50 | Turn and then stop | 9/50 |
| Slow walking | 50 | Turn and then rotate | 2/50 |
| | | in the original place | |
| Slow walking | 50 | Turn and then shake | 5/50 |
| | | in the original place | |
| | | (motion is not stopped, | |
| | | but orientation keeps | |
| | | unchanged) | |
| Walking | 50 | Turn and then stop | 7/50 |
| Walking | 50 | Turn and then rotate | 2/50 |
| | | in the original place | |
| Walking | 50 | Turn and then shake | 2/50 |
| | | in the original place | |
| | | (motion is not stopped, | |
| | | but orientation keeps | |
| | | unchanged) | |
| Running | 50 | Turn and then stop | 1/50 |
| Running | 50 | Turn and then rotate | 2/50 |
| | | in the original place | |
| Running | 50 | Turn and then shake | 2/50 |
| | | in the original place | |
| | | (motion is not stopped, | |
| | | but orientation keeps | |
| | | unchanged) | |
| Total number | 450 | Total failed | 32/450 |
| of persons | | identification rate | |
| tested | | | |

Table 10 and Table 11 are test and statistical results for to-be-identified turning events in different scenarios, respectively. The number of persons tested corresponding to the turning events and the number of persons tested corresponding to the non-turning events are respectively 450, and the corresponding false identification probabilities are 22/450 and 32/450, respectively.

The statistical result of a great number of tests shows that according to the turning event identification method provided by the embodiments of the present disclosure, the identification rate of the turning event can be increased to 96%, and the false identification rate for the non-turning event is only 5.6%, so that the positioning accuracy of the system for the position changes due to turning is greatly improved, the system can obtain the geographic position data in time and accurately when the user turns, and the motion trajectory accuracy is further improved.

In the embodiment of the present disclosure, by distinguishing the motion state of the user when a to-be-identified turning event occurs, and setting the preset motion turning condition and the preset non-motion turning condition, the identification accuracy of the turning event is further improved, and the false identification rate is greatly reduced. The positioning accuracy of the system for the position changes due to turning is greatly improved, the system can obtain the geographic position data in time and accurately when the user turns, the motion trajectory accuracy is further improved, and the motion trajectory is closer to the actual movement of the user.

FIG. 8 is a flowchart of an embodiment of a positioning method according to an embodiment of the present disclosure. The method is applicable to a server end, and the method may comprise:

801: receiving a positioning request sent by a terminal device;

wherein the positioning request is generated when the terminal device determines that a turning event occurs at the current moment; the turning event is determined by the terminal device based on the azimuth angle data collected by the first sensor and the acceleration data collected by the second sensor respectively.

802: obtaining position data of the current moment based on the positioning request;

803: generating a motion trajectory based on position points determined by the position data;

804: sending the motion trajectory to the terminal device to enable the terminal device to output the motion trajectory in a displayed map.

The specific implementation methods of the embodiments of the present disclosure have been described above in detail, and will not be repeated herein.

In the embodiment of the present disclosure, the azimuth angle data and the acceleration data when the user moves are collected through the terminal device, it is judged whether a turning event occurs at the current moment based on the collected azimuth angle data and the acceleration data, and the positioning request generated by the terminal device based on the turning event is received. The positioning point of the turning point position when the user turns during the movement is obtained by identifying and positioning the positional change caused by a turning action, so that the motion trajectory displayed on the map reflects the actual movement more truly.

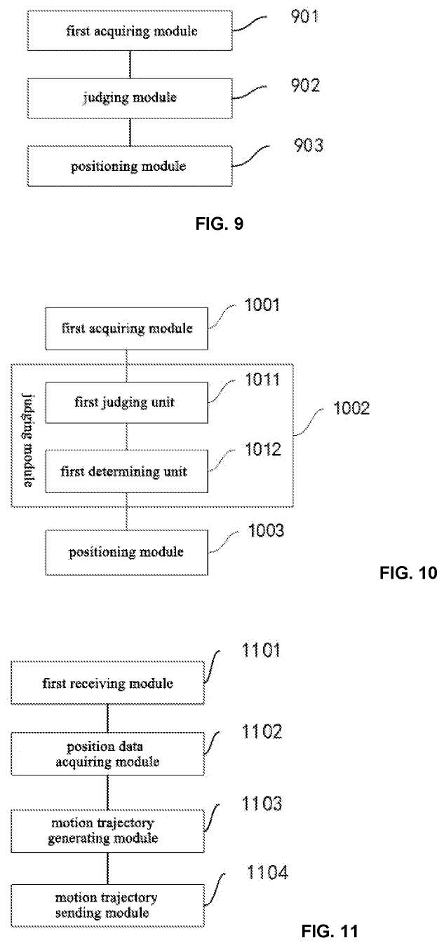

FIG. 9 is a schematic diagram of the structure of an embodiment of a positioning device according to an embodiment of the present disclosure. The device may comprise:

a first acquiring module 901 for acquiring azimuth angle data collected by a first sensor and acceleration data collected by a second sensor respectively;

a judging module 902 for judging whether a turning event occurs at a current moment based on the azimuth angle data and the acceleration data; and

a positioning module 903 for, if a turning event occurs, generating a positioning request to acquire position data of the current moment based on the positioning request for positioning and displaying.

The specific implementation methods of the embodiments of the present disclosure have been described above in detail, and will not be repeated herein.

In the embodiment of the present disclosure, the azimuth angle data and the acceleration data when the user moves are collected, and it is judged whether a turning event occurs at the current moment based on the collected azimuth angle data and the acceleration data. The positioning point of the turning point position when the user turns during the movement is obtained by identifying and positioning the positional change caused by a turning action, so that the motion trajectory displayed on the map reflects the actual movement more truly.

Alternatively, in some embodiments, the positioning module 903 may be specifically for:

if a turning event occurs, generating a positioning request;

sending the positioning request to a server end to enable the server end to acquire position data of a current moment based on the positioning request;

generating a motion trajectory based on positioning points determined by the position data; and

outputting the motion trajectory generated by the server end in a map.

In practical applications, if the positioning is performed at the server end, the generated positioning request needs to be sent to the server end, and the server end acquires the position data at the current moment in time based on the positioning request and uses it as a positioning point. When the motion trajectory is generated at the server end, the motion trajectory includes positioning points corresponding to the position data when the turning event occurs, so that the motion trajectory generated at the server end can reflect the movement of the user more truly.

With the actual movement of the user, the motion trajectory can also be updated in real time as the position of the user changes so as to display the real movement of the user in real time in the map of the wearable device.

FIG. 10 is a schematic diagram of the structure of yet another embodiment of a positioning device according to an embodiment of the present disclosure. The device may comprise:

a first acquiring module 1001 for acquiring azimuth angle data collected by a first sensor and acceleration data collected by a second sensor respectively; and

a judging module 1002 for judging whether a turning event occurs at a current moment based on the azimuth angle data and the acceleration data.

The judging module 1002 may comprise:

a first judging unit 1011 for judging whether a to-be-identified turning event occurs at the current moment based on the azimuth angle data;

Alternatively, in some embodiments, the first judging unit 1011 may be specifically for:

calculating an angle difference between a first azimuth angle data collected at a start moment in a preset time range and a second azimuth angle data collected at an end moment in the preset time range;

determining whether the angle difference is greater than an angle threshold; and

if the angle difference is greater than the angle threshold, determining that the to-be-identified turning event occurs at the current moment.

a first determining unit 1012 for, if a to-be-identified turning event occurs, determining whether the to-be-identified turning event is a turning event based on the acceleration data; and

a positioning module 1003 for, if the to-be-identified turning event is a turning event, generating a positioning request to acquire position data of the current moment based on the positioning request for positioning and displaying.

As an alternative embodiment, the first determining unit 1012 may be specifically for:

determining a motion state and a motion characteristic value corresponding to the to-be-identified turning event based on the acceleration data;

judging whether the motion state is of a motion type or a non-motion type;

if the motion state is of a motion type, determining that the to-be-identified turning event is the turning event when the motion characteristic value satisfies a preset motion turning condition; and

if the motion state is of a non-motion type, determining that the to-be-identified turning event is the turning event when the motion characteristic value satisfies a preset non-motion turning condition.

As an alternative embodiment, the motion characteristic value may include:

one or more of a standard deviation, a kurtosis, a characteristic ratio of the standard deviation to the kurtosis, a kurtosis difference, a fluctuation difference and a standard deviation difference of the acceleration data collected within a current preset time period;

wherein the kurtosis difference is a difference between a kurtosis of the acceleration data collected within the current preset time period and a kurtosis mean value of at least one previous preset time period adjacent to the current preset time period;

the fluctuation difference is a difference between a fluctuation value of the acceleration data collected within the current preset time period and the fluctuation mean value of at least one previous preset time period adjacent to the current preset time period; and

the standard deviation difference is an absolute difference between a standard deviation of the acceleration data collected within the current preset time period and a standard deviation mean value of at least one previous preset time period adjacent to the current preset time period.

In an alternative embodiment, if the motion state is of a motion type, judging whether the to-be-identified turning event is the turning event according to whether the motion characteristic value satisfies a preset motion turning condition is specifically for:

if the motion state is of a motion type, judging whether the motion characteristic value satisfies a preset motion turning condition;

if yes, determining that the to-be-identified turning event is the turning event;

if no, determining that the to-be-identified turning event is the non-turning event.

In an alternative embodiment, if the motion state is of a non-motion type, judging whether the to-be-identified turning event is the turning event according to whether the motion characteristic value satisfies a preset non-motion turning condition is specifically for:

if the motion state is of a non-motion type, judging whether the motion characteristic value satisfies a preset non-motion turning condition;

if yes, determining that the to-be-identified turning event is the turning event;

if no, determining that the to-be-identified turning event is the non-turning event.

Optionally, in some embodiments, if the motion state is of a motion type, determining that the to-be-identified turning event is the turning event when the motion characteristic value satisfies a preset motion turning condition may be specifically for:

if the motion state is of a motion type, judging whether the standard deviation is less than a first standard deviation threshold and whether the characteristic ratio is less than a first characteristic ratio threshold;

if the standard deviation is less than the first standard deviation threshold and the characteristic ratio is less than the first characteristic ratio threshold, and at the same time, the kurtosis difference is less than or equal to a first kurtosis difference threshold, and/or the kurtosis is less than or equal to a first kurtosis threshold, and/or the fluctuation difference is less than or equal to a first fluctuation difference threshold, determining that the motion characteristic value satisfies the preset motion turning condition, and determining that the to-be-identified turning event is the turning event;

if the standard deviation is greater than or equal to the first standard deviation threshold, and/or the characteristic ratio is greater than or equal to the first characteristic ratio threshold, further judging whether the fluctuation difference is greater than the first fluctuation threshold;

if the fluctuation difference is greater than the first fluctuation threshold, and at the same time, the standard deviation difference is less than or equal to a first standard deviation difference threshold, and/or the kurtosis difference is less than the first kurtosis difference threshold, and the kurtosis is less than or equal to the first kurtosis threshold, determining that the motion characteristic value satisfies the preset motion turning condition;

if the fluctuation difference is less than or equal to the first fluctuation threshold, determining that the motion characteristic value satisfies the preset motion turning condition, and determining that the to-be-identified turning event is the turning event.

Optionally, in some embodiments, if the motion state is of a non-motion type, determining that the to-be-identified turning event is the turning event when the motion feature value satisfies a preset non-motion turning condition may be specifically for:

if the motion state is of a non-motion type, determining whether the fluctuation difference is greater than a second fluctuation difference threshold;

if the fluctuation difference is greater than the second fluctuation difference threshold, further judging whether the characteristic ratio is less than a second characteristic ratio threshold;

if the characteristic ratio is less than the second characteristic ratio threshold, and at the same time, the kurtosis difference is less than or equal to a second kurtosis difference threshold, and/or the kurtosis is less than or equal to a second kurtosis threshold, and/or the standard deviation difference is less than or equal to a second standard deviation difference threshold, determining that the motion characteristic value satisfies the preset non-motion turning condition, and determining that the to-be-identified turning event is the turning event;

if the characteristic ratio is greater than or equal to the second characteristic ratio threshold, determining that the motion characteristic value satisfies the preset non-motion turning condition;

if the fluctuation difference is less than or equal to the second fluctuation difference threshold, further judging whether the characteristic ratio is less than a third characteristic ratio threshold;

if the characteristic ratio is less than the third characteristic ratio threshold, and at the same time, the kurtosis difference is less than or equal to a third kurtosis difference threshold, and/or the kurtosis is less than or equal to a third kurtosis threshold, and/or the standard deviation difference is less than or equal to a third standard deviation difference threshold, determining that the motion characteristic value satisfies the preset non-motion turning condition;

if the characteristic ratio is greater than or equal to the third characteristic ratio threshold, determining that the motion characteristic value satisfies the preset non-motion turning condition, and determining that the to-be-identified turning event is the turning event.

The specific implementation methods of the embodiments of the present disclosure have been described above in detail, and will not be repeated herein.

In the embodiment of the present disclosure, by distinguishing the motion state of the user when a to-be-identified turning event occurs, and setting the preset motion turning condition and the preset non-motion turning condition, the identification accuracy of the turning event is further improved, and the false identification rate is greatly reduced. The positioning accuracy of the system for the position changes due to turning is greatly improved, the system can obtain the geographic position data in time and accurately when the user turns, the motion trajectory accuracy is further improved, and the motion trajectory is closer to the actual movement of the user.

FIG. 11 is a schematic diagram of the structure of an embodiment of a positioning device according to an embodiment of the present disclosure. The device may comprise:

a first receiving module 1101 for receiving positioning request sent by terminal device;

wherein the positioning request is generated when the terminal device determines that a turning event occurs at a current moment; the turning event is determined by the terminal device based on the azimuth angle data collected by the first sensor and the acceleration data collected by the second sensor respectively.

a position data acquiring module 1102 for acquiring position data of a current moment based on the positioning request;

a motion trajectory generating module 1103 for generating a motion trajectory based on positioning points determined by the position data; and

a motion trajectory sending module 1104 for sending the motion trajectory to the terminal device to enable the terminal device to output the motion trajectory in a displayed map.

The specific implementation methods of the embodiments of the present disclosure have been described above in detail, and will not be repeated herein.

In the embodiment of the present disclosure, the azimuth angle data and the acceleration data when the user moves are collected through the terminal device, it is judged whether a turning event occurs at the current moment based on the collected azimuth angle data and the acceleration data, and the positioning request generated by the terminal device based on the turning event is received. The positioning point of the turning point position when the user turns during the movement is obtained by identifying and positioning the positional change caused by a turning action, so that the motion trajectory displayed on the map reflects the actual movement more truly.

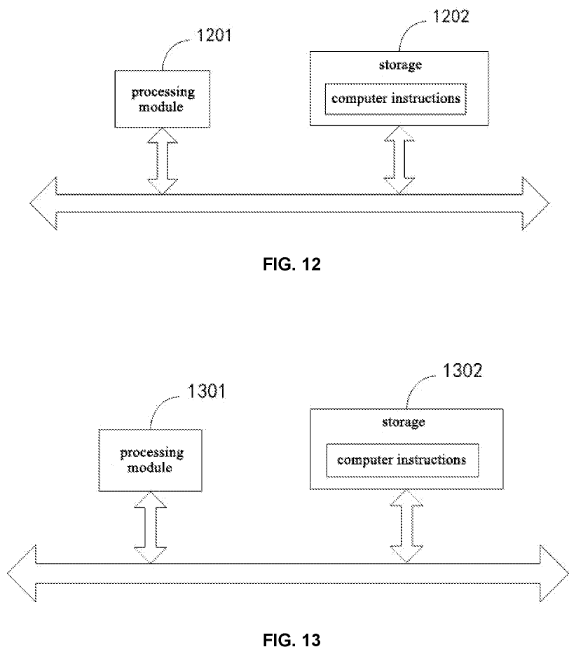

FIG. 12 is a schematic diagram of the structure of an embodiment of an electronic device according to an embodiment of the present disclosure. The terminal device may comprise a processing module 1201 and a storage module 1202 for storing one or more computer instructions, wherein the one or more computer instructions are invoked and executed by the processing module.

The processing module 1201 may be for:

acquiring azimuth angle data collected by a first sensor and acceleration data collected by a second sensor respectively;

judging whether a turning event occurs at a current moment based on the azimuth angle data and the acceleration data; and

if a turning event occurs, generating a positioning request to acquire position data of the current moment based on the positioning request for positioning and displaying.

The processing module 1201 may include one or more processors to execute computer instructions to perform all or a part of the steps in the methods described above. Of course, the processing modules may also be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic modules for performing the methods described above.

The storage module 1202 is configured to store various types of data to support the operations in the server. The storage module may be implemented by any type of volatile or non-volatile storage device, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

Of course, the device may further include other modules, such as input/output interfaces, communication modules, etc.

In practical applications, the electronic device may be a wearable device such as a smart bracelet, a smart watch, a locator, a smart headset, a smart clothing, etc., and may also be an electronic device such as a cell phone, a tablet computer, a navigator, etc.

The embodiments of the present disclosure also provide a computer readable storage medium having a computer program stored thereon which, when executed by a computer, can implement the positioning methods of the embodiments shown in FIG. 1 and FIG. 2.

FIG. 13 is a schematic diagram of the structure of an embodiment of a positioning server according to an embodiment of the present disclosure. The terminal device may include a processing module 1301 and a storage module 1302 for storing one or more computer instructions, wherein the one or more computer instructions are invoked and executed by the processing module. The processing module 1301 may be for:

receiving a positioning request sent by a terminal device, wherein the positioning request is generated when the terminal device determines that a turning event occurs at the current moment; the turning event is determined by the terminal device based on the azimuth angle data collected by the first sensor and the acceleration data collected by the second sensor respectively;

obtaining position data of the current moment based on the positioning request;

generating a motion trajectory based on the position point determined by the position data; and

sending the motion trajectory to the terminal device to enable the terminal device to output the motion trajectory in a displayed map.

The processing module 1301 may include one or more processors to execute computer instructions to perform all or a part of the steps in the methods described above. Of course, the processing modules may also be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic modules for performing the methods described above.

The storage module 1302 is configured to store various types of data to support the operations in the server. The storage module may be implemented by any type of volatile or non-volatile storage device, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

Of course, the positioning server may further include other modules, such as input/output interfaces, communication modules, etc.

The embodiments of the present disclosure also provide a computer readable storage medium having a computer program stored thereon which, when executed by a computer, can implement the posture information acquisition method of any of the above embodiments.

The embodiments of the present disclosure also provide a computer readable storage medium having a computer program stored thereon which, when executed by a computer, can implement the positioning method of the embodiment shown in FIG. 8.

The device embodiments described above are illustrative only, in which the unit described as a separate part may be or may be not physically separated, a part displayed as the unit may be or may be not a physical unit, may be located in one place, or may be distributed on a plurality of network units. Some or all of the modules may be selected to achieve the objective of the solutions of the embodiments according to actual requirements. Those ordinarily skilled in the art may understand and implement it without paying creative efforts.

As will be apparent to those skilled in the art from the description of the embodiments above, the embodiments may be implemented by software plus necessary general purpose hardware platform, although, of course, they may be implemented by hardware. Based on such an understanding, the above technical solutions may be embodied in the form of a software product, which may be stored in a computer-readable storage medium, such as a ROM/RAM, a magnetic disk, an optical disk and the like including several instructions for causing a computer device (which may be a personal computer, a server, or a network device, etc.) to perform the methods described in the embodiments or some parts of the embodiments.

Finally, it should also be noted that, the above embodiments are merely for explaining the technical solutions of the present disclosure, rather than limiting the present disclosure. Although the present disclosure has been described in detail with reference to the above embodiments, a person of ordinary skill in the art should understand that, changes may also be made to the technical solutions recorded in the preceding embodiments, or parts of the technical features thereof may be replaced by equivalents, which will not cause the corresponding technical solutions depart from the spirit and scope of the technical solutions in the embodiments of the present disclosure. It should also be noted that relational terms, such as first and second, etc. are used herein to distinguish one entity or operation from another entity or operation without necessarily requiring or implying any such actual relationship or order between such entities or operations. Moreover, the terms “comprise”, “include” or any other variations thereof are non-exclusive or open-ended, so that a process, method, article, or device including a series of elements includes not only those elements listed but also includes unspecified elements as well as elements that are inherent to such a process, method, article, or device. In the case that there is no more limitation, the phrase “comprising a . . . ” does not exclude that the process, method, article, or device including the named element further includes additional named element.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. A positioning method, comprising:
acquiring azimuth angle data collected by a first sensor and acceleration data collected by a second sensor respectively;
judging whether a turning event occurs at a current moment based on the azimuth angle data and the acceleration data; and
if a turning event occurs, generating a positioning request to acquire position data of the current moment based on the positioning request for positioning and displaying.

2. The method according to claim 1, wherein judging whether a turning event occurs at a current moment based on the azimuth angle data and the acceleration data comprises:
determining whether a to-be-identified turning event occurs at the current moment based on the azimuth angle data; and
if a to-be-identified turning event occurs, determining whether the to-be-identified turning event is the turning event based on the acceleration data.

3. The method according to claim 2, wherein determining whether a to-be-identified turning event occurs at the current moment based on the azimuth angle data comprises:
calculating an angle difference between a first azimuth angle data collected at a start moment in a preset time range and a second azimuth angle data collected at an end moment in the preset time range;
determining whether the angle difference is greater than an angle threshold; and
if the angle difference is greater than the angle threshold, determining that the to-be-identified turning event occurs at the current moment.

4. The method according to claim 2, wherein if a to-be-identified turning event occurs, determining whether the to-be-identified turning event is the turning event based on the acceleration data comprises:
determining a motion state and a motion characteristic value corresponding to the to-be-identified turning event based on the acceleration data;
judging whether the motion state is of a motion type or a non-motion type;
if the motion state is of a motion type, determining that the to-be-identified turning event is the turning event when the motion characteristic value satisfies a preset motion turning condition; and
if the motion state is of a non-motion type, determining that the to-be-identified turning event is the turning event when the motion characteristic value satisfies a preset non-motion turning condition.

5. The method according to claim 4, wherein
the motion characteristic value includes one or more of a standard deviation, a kurtosis, a characteristic ratio of the standard deviation to the kurtosis, a kurtosis difference, a fluctuation difference and a standard deviation difference of the acceleration data collected within a current preset time period;
wherein the kurtosis difference is a difference between a kurtosis of the acceleration data collected within the current preset time period and a kurtosis mean value of at least one previous preset time period adjacent to the current preset time period;
the fluctuation difference is a difference between a fluctuation value of the acceleration data collected within the current preset time period and the fluctuation mean value of at least one previous preset time period adjacent to the current preset time period; and
the standard deviation difference is an absolute difference between a standard deviation of the acceleration data collected within the current preset time period and a standard deviation mean value of at least one previous preset time period adjacent to the current preset time period.

6. The method according to claim 5, wherein if the motion state is of a motion type, determining that the to-be-identified turning event is the turning event when the motion characteristic value satisfies a preset motion turning condition comprises:
if the motion state is of a motion type, judging whether the standard deviation is less than a first standard deviation threshold and whether the characteristic ratio is less than a first characteristic ratio threshold;
if the standard deviation is less than the first standard deviation threshold and the characteristic ratio is less than the first characteristic ratio threshold, and at the same time, the kurtosis difference is less than or equal to a first kurtosis difference threshold, and/or the kurtosis is less than or equal to a first kurtosis threshold, and/or the fluctuation difference is less than or equal to a first fluctuation difference threshold, determining that the motion characteristic value satisfies the preset motion turning condition, and determining that the to-be-identified turning event is the turning event;
if the standard deviation is greater than or equal to the first standard deviation threshold, and/or the characteristic ratio is greater than or equal to the first characteristic ratio threshold, further judging whether the fluctuation difference is greater than the first fluctuation threshold;
if the fluctuation difference is greater than the first fluctuation threshold, and at the same time, the standard deviation difference is less than or equal to a first standard deviation difference threshold, and/or the kurtosis difference is less than the first kurtosis difference threshold, and the kurtosis is less than or equal to the first kurtosis threshold, determining that the motion characteristic value satisfies the preset motion turning condition;
if the fluctuation difference is less than or equal to the first fluctuation threshold, determining that the motion characteristic value satisfies the preset motion turning condition, and determining that the to-be-identified turning event is the turning event.

7. The method according to claim 5, wherein if the motion state is of a non-motion type, determining that the to-be-identified turning event is the turning event when the motion characteristic value satisfies a preset non-motion turning condition comprises:
if the motion state is of a non-motion type, determining whether the fluctuation difference is greater than a second fluctuation difference threshold;
if the fluctuation difference is greater than the second fluctuation difference threshold, further judging whether the characteristic ratio is less than a second characteristic ratio threshold;
if the characteristic ratio is less than the second characteristic ratio threshold, and at the same time, the kurtosis difference is less than or equal to a second kurtosis difference threshold, and/or the kurtosis is less than or equal to a second kurtosis threshold, and/or the standard deviation difference is less than or equal to a second standard deviation difference threshold, determining that the motion characteristic value satisfies the preset non-motion turning condition, and determining that the to-be-identified turning event is the turning event;
if the characteristic ratio is greater than or equal to the second characteristic ratio threshold, determining that the motion characteristic value satisfies the preset non-motion turning condition;
if the fluctuation difference is less than or equal to the second fluctuation difference threshold, further judging whether the characteristic ratio is less than a third characteristic ratio threshold;
if the characteristic ratio is less than the third characteristic ratio threshold, and at the same time, the kurtosis difference is less than or equal to a third kurtosis difference threshold, and/or the kurtosis is less than or equal to a third kurtosis threshold, and/or the standard deviation difference is less than or equal to a third standard deviation difference threshold, determining that the motion characteristic value satisfies the preset non-motion turning condition;
if the characteristic ratio is greater than or equal to the third characteristic ratio threshold, determining that the motion characteristic value satisfies the preset non-motion turning condition, and determining that the to-be-identified turning event is the turning event.

8. The method according to claim 1, wherein if a turning event occurs,
generating a positioning request to acquire position data of the current moment based on the positioning request for positioning and displaying comprises:
if a turning event occurs, generating a positioning request;
sending the positioning request to a server end to enable the server end to acquire position data of a current moment based on the positioning request;
generating a motion trajectory based on positioning points determined by the position data; and
outputting the motion trajectory generated by the server end in a map.

9. An electronic device comprising a processing module and a storage module; the storage module is for storing one or more computer instructions, wherein the one or more computer instructions are invoked and executed by the processing module;
the processing module is for:
acquiring azimuth angle data collected by a first sensor and acceleration data collected by a second sensor respectively;
judging whether a turning event occurs at a current moment based on the azimuth angle data and the acceleration data; and
if a turning event occurs, generating a positioning request to acquire position data of the current moment based on the positioning request for positioning and displaying.

10. A computer readable storage medium storing a computer program, wherein the computer program, when executed by a computer, can implement a positioning method, which comprises the steps of:
acquiring azimuth angle data collected by a first sensor and acceleration data collected by a second sensor respectively;
judging whether a turning event occurs at a current moment based on the azimuth angle data and the acceleration data; and
if a turning event occurs, generating a positioning request to acquire position data of the current moment based on the positioning request for positioning and displaying.

11. The computer readable storage medium according to claim 10, wherein
judging whether a turning event occurs at a current moment based on the azimuth angle data and the acceleration data comprises:
determining whether a to-be-identified turning event occurs at the current moment based on the azimuth angle data; and
if a to-be-identified turning event occurs, determining whether the to-be-identified turning event is the turning event based on the acceleration data.

12. A computer readable storage medium according to claim 10, wherein determining whether a to-be-identified turning event occurs at the current moment based on the azimuth angle data comprises:
calculating an angle difference between a first azimuth angle data collected at a start moment in a preset time range and a second azimuth angle data collected at an end moment in the preset time range;
determining whether the angle difference is greater than an angle threshold; and
if the angle difference is greater than the angle threshold, determining that the to-be-identified turning event occurs at the current moment.

13. A computer readable storage medium according to claim 10, wherein if a to-be-identified turning event occurs, determining whether the to-be-identified turning event is the turning event based on the acceleration data comprises:
determining a motion state and a motion characteristic value corresponding to the to-be-identified turning event based on the acceleration data;
judging whether the motion state is of a motion type or a non-motion type;
if the motion state is of a motion type, determining that the to-be-identified turning event is the turning event when the motion characteristic value satisfies a preset motion turning condition; and
if the motion state is of a non-motion type, determining that the to-be-identified turning event is the turning event when the motion characteristic value satisfies a preset non-motion turning condition.

14. A computer readable storage medium according to claim 10, wherein
the motion characteristic value includes one or more of a standard deviation, a kurtosis, a characteristic ratio of the standard deviation to the kurtosis, a kurtosis difference, a fluctuation difference and a standard deviation difference of the acceleration data collected within a current preset time period;
wherein the kurtosis difference is a difference between a kurtosis of the acceleration data collected within the current preset time period and a kurtosis mean value of at least one previous preset time period adjacent to the current preset time period;
the fluctuation difference is a difference between a fluctuation value of the acceleration data collected within the current preset time period and the fluctuation mean value of at least one previous preset time period adjacent to the current preset time period; and
the standard deviation difference is an absolute difference between a standard deviation of the acceleration data collected within the current preset time period and a standard deviation mean value of at least one previous preset time period adjacent to the current preset time period.

15. A computer readable storage medium storing according to claim 10, wherein if the motion state is of a motion type, determining that the to-be-identified turning event is the turning event when the motion characteristic value satisfies a preset motion turning condition comprises:
if the motion state is of a motion type, judging whether the standard deviation is less than a first standard deviation threshold and whether the characteristic ratio is less than a first characteristic ratio threshold;
if the standard deviation is less than the first standard deviation threshold and the characteristic ratio is less than the first characteristic ratio threshold, and at the same time, the kurtosis difference is less than or equal to a first kurtosis difference threshold, and/or the kurtosis is less than or equal to a first kurtosis threshold, and/or the fluctuation difference is less than or equal to a first fluctuation difference threshold, determining that the motion characteristic value satisfies the preset motion turning condition, and determining that the to-be-identified turning event is the turning event;
if the standard deviation is greater than or equal to the first standard deviation threshold, and/or the characteristic ratio is greater than or equal to the first characteristic ratio threshold, further judging whether the fluctuation difference is greater than the first fluctuation threshold;
if the fluctuation difference is greater than the first fluctuation threshold, and at the same time, the standard deviation difference is less than or equal to a first standard deviation difference threshold, and/or the kurtosis difference is less than the first kurtosis difference threshold, and the kurtosis is less than or equal to the first kurtosis threshold, determining that the motion characteristic value satisfies the preset motion turning condition;
if the fluctuation difference is less than or equal to the first fluctuation threshold, determining that the motion characteristic value satisfies the preset motion turning condition, and determining that the to-be-identified turning event is the turning event.

16. A computer readable storage medium according to claim 10, wherein if the motion state is of a non-motion type, determining that the to-be-identified turning event is the turning event when the motion characteristic value satisfies a preset non-motion turning condition comprises:
if the motion state is of a non-motion type, determining whether the fluctuation difference is greater than a second fluctuation difference threshold;
if the fluctuation difference is greater than the second fluctuation difference threshold, further judging whether the characteristic ratio is less than a second characteristic ratio threshold;
if the characteristic ratio is less than the second characteristic ratio threshold, and at the same time, the kurtosis difference is less than or equal to a second kurtosis difference threshold, and/or the kurtosis is less than or equal to a second kurtosis threshold, and/or the standard deviation difference is less than or equal to a second standard deviation difference threshold, determining that the motion characteristic value satisfies the preset non-motion turning condition, and determining that the to-be-identified turning event is the turning event;
if the characteristic ratio is greater than or equal to the second characteristic ratio threshold, determining that the motion characteristic value satisfies the preset non-motion turning condition;
if the fluctuation difference is less than or equal to the second fluctuation difference threshold, further judging whether the characteristic ratio is less than a third characteristic ratio threshold;
if the characteristic ratio is less than the third characteristic ratio threshold, and at the same time, the kurtosis difference is less than or equal to a third kurtosis difference threshold, and/or the kurtosis is less than or equal to a third kurtosis threshold, and/or the standard deviation difference is less than or equal to a third standard deviation difference threshold, determining that the motion characteristic value satisfies the preset non-motion turning condition;
if the characteristic ratio is greater than or equal to the third characteristic ratio threshold, determining that the motion characteristic value satisfies the preset non-motion turning condition, and determining that the to-be-identified turning event is the turning event.

17. A computer readable storage medium according to claim 10, wherein if a turning event occurs, generating a positioning request to acquire position data of the current moment based on the positioning request for positioning and displaying comprises:
if a turning event occurs, generating a positioning request;
sending the positioning request to a server end to enable the server end to acquire position data of a current moment based on the positioning request;
generating a motion trajectory based on positioning points determined by the position data; and
outputting the motion trajectory generated by the server end in a map.
